(19) United States
(12) Patent Application Publication
(10) Pub. No.: US 2021/0394153 A1
(43) Pub. Date: Dec. 23, 2021

(54) ADSORBENT, PROCESS FOR PRODUCING THEREOF, AND ADSORBENT MOLDED ARTICLE

(71) Applicant: MITSUI MINING & SMELTING CO., LTD., Tokyo (JP)

(72) Inventors: Hiroyuki KAJITA, Saitama (JP); Kazuya KINOSHITA, Saitama (JP); Jun-ichi ITOH, Saitama (JP); Atsushi KUROSAKI, Saitama (JP)

(21) Appl. No.: 17/287,757

(22) PCT Filed: Oct. 24, 2019
(86) PCT No.: PCT/JP2019/041737

§ 371 Date: Apr. 22, 2021

(30) Foreign Application Priority Data
Oct. 24, 2018 (JP) 2018-199953

(51) Int. Cl. B01J 20/02; B01J 20/30; C02F 1/28

(52) U.S. Cl. CPC B01J 20/0207; B01J 20/3078; C02F 2101/14; C02F 1/281; B01J 20/3007

(57) ABSTRACT

An adsorbent is provided which can improve the fluorine adsorption capacity and the breakthrough time compared with conventional adsorbents, particularly an adsorbent which can be suitably used as a fluorine adsorbent. The adsorbent comprises rare earth compound particles comprising a rare earth oxycarbonate or a hydrate thereof.

### CROSS REFERENCE TO RELATED APPLICATIONS

This is a U.S. National Phase Application under 35 U.S.C. 371 of International Application No. PCT/JP2019/041737, filed on Oct. 24, 2019, which claims priority to Japanese Patent Application No. 2018-199953, filed on Oct. 24, 2018. The entire disclosures of the above applications are expressly incorporated by reference herein.

### BACKGROUND

### Technical Field

The present invention relates to an adsorbent which adsorbs fluorine, a method for producing the same, and an adsorbent molded article using the adsorbent.

### Related Art

As a general method for removing particularly fluorine among elements contained in an aqueous solution such as waste water, a method is known in which fluorine is precipitated and removed as poorly-soluble calcium fluoride by using a fluorine precipitation material such as calcium hydroxide or calcium oxide, and even fluorine-containing waste water discharged from chemical industry, etc. is also treated by using the fluorine precipitation material described above.

Due to social demands, wastewater treatment standards for hazardous substances and pollutants have become stricter in recent years, and at present (as of October 2018), the wastewater standard for fluorine is determined as 8 ppm or less in Japan; however, it is possible that a lower concentration standard will be applied in the future. In order to meet the above-mentioned wastewater standards, simple removal with a fluorine precipitating material is not enough, and thus a two-steps process is conducted in which the wastewater whose fluorine content has been reduced by a treatment using a fluorine precipitating material is further treated using an adsorbent so that the fluorine concentration becomes equal to or less than the standard value.

Various methods for removing fluorine by the adsorbent as described above are known, and for example, a method using an ion exchange resin, an active alumina poorly-soluble substance, or a rare earth compound are known (Japanese Patent Application Publication No. S60-153940). Among these fluorine adsorbents, a rare earth compound is known as a method for removing fluorine in waste water treatment, which the treatment is carried out in two-steps because it can remove fluorine even with a waste fluid in which the fluorine is dissolved in a low concentration, as well as having a large capacity of fluorine adsorption and a long breakthrough time, and also it can reduce exchange frequency (regeneration frequency) of the adsorbent.

As a fluorine adsorption method using such a rare earth compound, for example, Japanese Patent Application Publication No. 2005-028312 proposes the use of a fluorine adsorbent comprising a polymer resin and a water-containing substance (water-containing oxide) of a rare earth oxide. Japanese Patent Application Publication No. 2002-001313 proposes the adsorption of fluorine by using a rare earth compound such as a rare earth oxide, a rare earth hydroxide, or a rare earth carbonate in a basic state with respect to a waste water in which the fluorine concentration has been reduced by a precipitation method.

The rare earth compounds used in the above-mentioned Japanese Patent Application Publication Nos. S60-153940, 2005-028312, and 2002-001313 have a common feature of adsorbing and removing fluorine; however, all of the adsorbents do not have sufficient treatment ability to remove fluorine over a long period, and there had been limits to increase the fluorine adsorption capacity and prolong the breakthrough time.

Accordingly, it is an object of the present invention to provide an adsorbent having improved fluorine adsorption capacity and improved breakthrough time than ever, particularly an adsorbent which can be suitably used as a fluorine adsorbent.

Another object of the present invention is to provide a method for producing the above-described adsorbent, a method for removing fluorine by the adsorbent, and an adsorbent molded article using the adsorbent.

### SUMMARY

The present inventors have recently found that when a rare earth carbonate is oxidized under specific oxidation conditions, a rare earth oxide is formed via the rare earth oxycarbonate in the process of oxidizing a rare earth carbonate to obtain a rare earth oxide. The present inventors have obtained the knowledge that, using a material containing a rare earth oxycarbonate as a fluorine adsorbent makes it possible to remove fluorine by a chemical reaction between the rare earth oxycarbonate and fluorine, and as a result, fluorine adsorption capacity and breakthrough life were improved, thereby completing the present invention.

That is, disclosed is an adsorbent comprising rare earth compound particles comprising a rare earth oxycarbonate or a hydrate thereof.

A method for producing an adsorbent of the present invention comprises a step of heating a rare earth carbonate in a gas atmosphere comprising oxygen at a temperature of 100° C. or higher and lower than 180° C. or a step of heating in water at a temperature of 60° C. to 100° C.

A method for removing fluorine from a fluorine-containing solution by using the adsorbent of the present invention comprises:
a step of bringing the fluorine-containing solution into contact with the adsorbent; and
a step of chemically reacting rare earth compound particles in the adsorbent with the fluorine in the fluorine-containing solution to form at least one fluoride selected from the group consisting of a rare earth fluoride and a rare earth carbonate fluoride.

An adsorbent molded article of the present invention comprises the above-described adsorbent and a binder.

### Effect of the Invention

According to the present invention, when rare earth compound particles in the adsorbent contain a rare earth oxycarbonate or a hydrate thereof, the rare earth oxycarbonate chemically reacts with fluorine, so that the fluorine adsorption capacity and the breakthrough time can be improved.

### BRIEF DESCRIPTION OF THE DRAWINGS

FIG. 1 is a powder X-ray diffraction spectrum of the adsorbents (cerium compound particles) of Example 1 and Comparative Example 1;

FIG. 2 is a powder X-ray diffraction spectrum of the adsorbent (cerium compound particles) of Example 4 before and after evaluation of the fluorine adsorption performance;

FIG. 3 is a powder X-ray diffraction spectrum of the adsorbents (cerium compound particles) of Example 1 and Comparative Example 1 after evaluation of the fluorine adsorption performance; and

FIG. 4 is a change in fluorine concentration with respect to the water passage time of the adsorbent molded articles of Example 1, Comparative Examples 1 and 2.

### DETAILED DESCRIPTION

### Adsorbent

An adsorbent of the present invention comprises rare earth compound particles comprising a rare earth oxycarbonate or a hydrate thereof. The rare earth compound particles constituting the adsorbent of the present invention will be described below.

### Rare Earth Compound Particles

The rare earth compound particles constituting the adsorbent of the present invention comprise a rare earth oxycarbonate or a hydrate thereof. Rare earth oxides, conventionally known as a fluorine adsorbent, adsorb fluorine and since fluorine chemically reacts with a rare earth oxycarbonate or a hydrate thereof to form a fluoride by using a rare earth oxycarbonate or a hydrate thereof as an adsorbent, the fluorine adsorption capacity and the breakthrough time can be improved as compared with the prior arts. Particularly, from the viewpoint of reactivity with fluorine, it is preferable to use a rare earth oxycarbonate.

In the present invention, “a rare earth oxycarbonate or a hydrate thereof” refers to a compound represented by either of the following formulae:

Rₓ(CO₃)₂O·nH₂O

Rₓ(CO₃)O₂·nH₂O
wherein R represents a rare earth element, x=1 to 2, and n=0 to 8.

In the present invention, the rare earth compound particles may further comprise a rare earth oxide in addition to the rare earth oxycarbonate or a hydrate thereof. As will be described later, the rare earth compound particles are produced by using a rare earth carbonate as a starting material and oxidizing the rare earth carbonate under a predetermined condition. In some cases, the rare earth carbonate is oxidized to form the rare earth oxide via the rare earth oxycarbonate. Since the rare earth compound particles contain the rare earth oxide in addition to the rare earth oxycarbonate or a hydrate thereof, the chemical reaction of fluorine by the rare earth oxycarbonate and the adsorption of fluorine by the rare earth oxide exhibit a synergistic effect, which as a result, particularly improves the fluorine adsorption capacity and the breakthrough time.

Note that, in the present invention, “rare earth oxide” refers to a compound represented by the following formula:

R_{y}O_{z}
wherein R represents a rare earth element, y=1 to 2, and z=1 to 3.

When the rare earth compound particles contain a rare earth oxycarbonate or a hydrate thereof and a rare earth oxide, it is preferable that the rare earth oxycarbonate or a hydrate thereof is contained in a ratio of a certain degree or more. That is, when a peak intensity derived from the rare earth oxycarbonate or a hydrate thereof is represented by I_{ca} and a peak intensity derived from the rare earth oxide is represented by lₒₓ in monochromatic powder X-ray diffraction analysis of the rare earth compound particles, the peak intensity ratio represented by I_{ca}/lₒₓ being 0.1 or more can make the balance between the adsorption of fluorine and the chemical reaction preferable, and as a result, the fluorine adsorption capacity and the breakthrough time can be further improved. In particular, from the viewpoint of fluorine adsorption capacity and the breakthrough time, the peak intensity ratio is more preferably 0.2 or more. The upper limit of the peak intensity ratio is preferably 10 or less, more preferably 5 or less, and particularly preferably 1 or less, in consideration of the balance between the adsorption of fluorine and the chemical reaction by the rare earth oxycarbonate or a hydrate thereof and the rare earth oxide.

The peak intensity (I_{ca}) derived from a rare earth oxycarbonate or a hydrate thereof refers to a peak intensity having a maximum peak intensity within the range of 10° to 30° among the monochromatic powder X-ray diffraction peaks ascribed to the rare earth oxycarbonate. The peak intensity (lₒₓ) derived from a rare earth oxide is a peak intensity having a maximum peak intensity within the range of 10° to 30° among the monochromatic powder X-ray diffraction peaks attributed to the rare earth oxide. For example, in the case where the rare earth is cerium (Ce), a peak derived from a crystal phase (maximum intensity) appears around 2θ=20.5° in the monochromatic powder X-ray diffraction analysis of cerium carbonate or a hydrate thereof. In the monochromatic powder X-ray diffraction analysis of a cerium oxide, a peak derived from a crystal phase (maximum intensity) appears around 2θ=28.50°. Note that, the monochromatic powder X-ray diffraction analysis is performed using a CuK α line.

Examples of the rare earth element (“R” in the present invention) constituting the rare earth compound are preferably lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y) and scandium (Sc), and cerium (Ce) is preferable from the viewpoint of making the effect of the present invention even more significant.

From the viewpoint of making the effect of the present invention even more significant, the average particle size of the rare earth compound particles is preferably 10 μm or less, more preferably 5 μm or less. Note that, the average particle size means the volume cumulative particle diameter D₅₀ measured by a laser diffraction particle diameter distribution measuring apparatus. The average particle size of the rare earth compound particles can be adjusted as needed by mechanical grinding using a bead mill or the like in the manufacturing process of the rare earth compound particles so that they fall within the above-mentioned range. However, the present invention is not limited to such method. Note that, the lower limit of the average particle size is preferably 0.1 μm or more in consideration of the strength when made into an adsorbent.

As the rare earth compound particles, compounds other than the above-described rare earth oxycarbonate or a hydrate thereof and the rare earth oxide may be contained, and for example, a rare earth hydroxycarbonate (rare earth salt having a carbonate group and a hydroxyl group) or a rare earth carbonate may be contained. The content of these compounds in the rare earth compound particles is preferably 10% by mass or less, more preferably 3% by mass or less, from the viewpoint of preventing the effect of the present invention from being impaired.

Next, a method for producing a rare earth compound of the present invention will be described. As one example, a rare earth carbonate is used as a starting material. A rare earth compound containing a rare earth oxycarbonate or a hydrate thereof can be obtained by oxidizing the rare earth carbonate under certain conditions.

Specifically, a rare earth carbonate is heated in a gas atmosphere containing oxygen at a temperature of 100° C. or higher and lower than 180° C., whereby a rare earth compound containing a rare earth oxycarbonate or a hydrate thereof can be obtained. By setting the heating temperature in the gas atmosphere containing oxygen to lower than 180° C., it is possible to prevent excessive oxidation of the rare earth carbonate and to prevent the ratio of the rare earth oxide to the rare earth oxycarbonate or a hydrate thereof from increasing excessively. Further, by setting the heating temperature in the gas atmosphere containing oxygen at a temperature of 100° C. or higher, it is possible to prevent the rare earth carbonate in the rare earth compound particles from remaining, and the fluorine adsorption capacity and the breakthrough time can be made sufficient. The preferred heating temperature is 120° C. to 170° C.

Note that, the gas atmosphere containing oxygen may be an air atmosphere or a mixed gas atmosphere of oxygen gas and inert gas such as argon. The oxygen concentration of the mixed gas is not particularly limited as long as it is capable of oxidizing the rare earth carbonate.

A rare earth compound containing a rare earth oxycarbonate or a hydrate thereof can also be obtained by heating the rare earth carbonate in water at a temperature of 60° C. to 100° C. More preferably, the heating temperature is 80° C. to 100° C. When the rare earth carbonate is heated in water in the above temperature range for about 1 hour to 10 hours, the rare earth oxide is hardly formed.

A method for removing fluorine from the fluorine-containing solution using the adsorbent of the present invention is not particularly limited, and may be performed by a conventionally known method. For example, fluorine can be removed from the fluorine-containing water by attaching the adsorbent to a nonwoven fabric, etc. and immersing the nonwoven fabric or the like in the fluorine-containing water to bring the nonwoven fabric or the like into contact with the fluorine-containing water. The fluorine concentration of the fluorine-containing water assumed in the present invention is about several tens of mg/L, without particular limitation.

### Adsorbent Molded Article

The adsorbent molded article of the present invention includes the above-described adsorbent and a binder. The binder has a role of attaching the adsorbent to each other and maintaining the strength of the adsorbent molded article. In the present invention, the adsorbent is preferably contained in an amount of 90% by mass or more with respect to the entire adsorbent molded article. The more the proportion of the adsorbent contained in the adsorbent molded article increases, the fluorine adsorption capacity and the breakthrough time are improved. However, when the proportion of the binder extremely decreases, it becomes impossible to bind the adsorbent to each other, and thus the strength of the adsorbent molded article decreases. Therefore, the content of the adsorbent contained in the adsorbent molded article is preferably 98% by mass or less, and more preferably 95% by mass or less.

The method for confirming the content of the adsorbent contained in the adsorbent molded article of the present invention differs depending on whether the binder is an organic binder or an inorganic binder, as described later. In the case of an organic binder, the content can be confirmed by measuring the mass ratio of the residue (ash part) after the binder component is removed by heat treatment of the binder to the total mass of the adsorbent molded article. In the case of an inorganic binder, the content can be confirmed by separating the adsorbent and the inorganic binder and analyzing the masses of the two by X-ray fluorescence analysis (XRF).

Any binder can be used without particular limitation as long as it can bind the adsorbents to each other, and examples thereof include organic binders such as a polysulfone polymer, a polyvinylidene fluoride polymer, a polyvinylidene chloride polymer, a polyacrylonitrile polymer, an acrylic ester polymer, a polyamide polymer, a polyimide polymer, and a cellulose polymer. Further, examples include inorganic binders such as lithium silicate, sodium silicate, magnesium silicate, calcium silicate, potassium silicate, strontium silicate, barium silicate, aluminum silicate, kaolinite, zirconium acetate, aluminum oxyhydroxide, aluminum hydroxide, aluminum phosphate, magnesium phosphate, fumed silica, Portland cement, alumina cement, and the like.

Among the above-described binders, an organic binder that is difficult to dissolve in water is preferably used from the viewpoint of durability of the adsorbent molded article, and preferred are acrylic acid ester based polymers, polyacrylonitrile based polymers, polysulfone based polymers, and polyvinylidene fluoride based polymers. When water is used as a dispersion medium as described later, it is preferable to use an aqueous emulsion of the above-described polymer. The polymer in the form of an aqueous emulsion can be obtained by a known means such as emulsion polymerization in water.

When an adsorbent molded article is produced by extrusion molding or the like, water is usually used as a dispersion medium, and in this case, a plasticizer may be added for the purpose of imparting fluidity, shape retention, and the like. Examples of the plasticizer include cellulose ethers such as methyl cellulose, polysaccharides, polyvinyl alcohol, water-soluble polymers such as starch, and the like. One of these plasticizers may be used alone, or may be used in any combination. Also, a conventionally used dispersant or the like may be added as needed.

### Method for Producing Adsorbent Molded Article

The adsorbent molded article comprising the adsorbent, the binder and optionally the plasticizer or the like can be produced by a known method. In the production process, a porous adsorbent molded article can be obtained by appropriately adjusting the blending ratio of the rare earth compound particles, the binder, and the plasticizer, or the like. For example, the rare earth compound particles, 3 to 20% of the binder with respect to the rare earth compound particles on a mass basis, 0 to 5% of the plasticizer with respect to the rare earth compound particles on a mass basis, and 20 to 50% of pure water with respect to the rare earth compound particles on a mass basis are mixed. A known means can be used for the mixing method without particular limitation, and for example, a kneader, a mixer, a high-speed stirrer, etc. can be applied. The kneaded material obtained by the mixing is subjected to extrusion granulation to obtain a granulated material, and then the granulated material is subjected to granulation by a granulator to obtain a molded article having a desired size. Then, by drying and, if necessary, firing, it is possible to obtain a porous adsorbent molded article. The adsorbent molded article after the particle adjustment is preferably in a substantially cylindrical shape having a diameter of 0.3 to 1 mm and a length of 0.5 to 5 mm.

The adsorbent molded article obtained as described above typically has a porous shape in which micropores communicate with each other. The adsorbent molded article of the present invention preferably has a specific surface area of 30 to 200 m²/g. In the present invention, the specific surface area is defined as a value measured by the BET method, and specifically, an inert gas (e.g., nitrogen gas) having a known molecular size is adsorbed on the surface of a measurement sample, and the specific surface area can be obtained from the amount of the inert gas adsorbed and the area occupied by the inert gas.

### Application of Adsorbent Molded Article

The adsorbent molded article of the present invention can be suitably used as a fluorine adsorbent. The adsorbent molded article of the present invention has a larger fluorine adsorption capacity and a longer breakthrough time than a fluorine adsorbent using a conventional rare-earth compound, and therefore, the adsorbent can have reduced frequency of exchange (regeneration frequency).

The method for removing fluorine from the fluorine-containing solution using the adsorbent molded article of the present invention is not particularly limited, and may be performed by a conventionally known method. For example, fluorine can be removed by passing fluorine-containing water through the adsorbent molded article so that they are brought into contact. The conditions for passing water through the adsorbent molded article are not particularly limited, but the fluorine adsorption capacity and the breakthrough time can be further improved by making the fluorine-containing water acidic. The fluorine-containing solution is adjusted so that the acidic conditions are preferably pH5 or less, and more preferably the pH is 3 or less. The fluorine concentration of the fluorine-containing water assumed in the present invention is about several tens of mg/L, without particular limitation.

The characteristic of the present invention is that the rare earth compound particles constituting the adsorbent contain a rare earth oxycarbonate or a hydrate thereof. As described above, it is also a characteristic that, since the rare earth oxycarbonate or a hydrate thereof reacts with fluorine to form a rare earth fluoride or a rare earth carbonate fluoride, when the adsorbent of the present invention is used as a fluorine adsorbent, the used adsorbent has the rare earth fluoride or the rare earth carbonate fluoride generated or even both generated. Without being bound by theory, it is believed that rare earth oxycarbonate and fluorine react chemically to form a rare earth carbonate fluoride, which is further fluorinated to form a rare earth fluoride.

In the present invention, the term “rare earth fluoride” refers to a compound represented by the following formula:

RₚF_{q}

wherein R represents a rare earth element, p=1 to 2, and q=1 to 4.

The “rare earth carbonate fluoride” means a compound represented by the following formula:

R(CO₃)F

wherein R represents a rare earth element.

The content of the rare earth fluoride or the rare earth carbonate fluoride in the rare earth compound particles is preferably 10 mass % or less from the viewpoint of exhibiting the performance as the adsorbent of the present invention.

### EXAMPLES

Next the embodiments of the present invention will now be specifically described with reference to the following Examples; however, the present invention shall not be limited thereby.

### Example 1

Cerium carbonate (manufactured by Nippon Yttrium Co., Ltd., average particle size: 56 μm) was wet-milled and then heated in air at a temperature of 140° C. for 12 hours to obtain an adsorbent comprising cerium compound particles.

The adsorbent thus obtained was measured for a powder X-ray diffraction spectrum using a powder X-ray diffractometre (RINT-TTR III, manufactured by Rigaku Corporation) with output: 50 kV and 300 mA, measurement range (deg): 10 to 80°, step width: 0.01 deg, scan speed: 0.2 deg/min, incident slit (deg) of ⅔, longitudinal slit: 10 mm, monochrometre, and one dimensional detector.

### Example 2

An adsorbent made of cerium compound particles was obtained in the same manner as in Example 1 except that the heating temperature was set to 120° C. Next, a powder X-ray diffraction spectrum of the adsorbent was measured in the same manner as in Example 1.

### Example 3

An adsorbent made of cerium compound particles was obtained in the same manner as in Example 1 except that the heating temperature was set to 160° C. Next, a powder X-ray diffraction spectrum of the adsorbent was measured in the same manner as in Example 1.

### Example 4

An adsorbent made of cerium compound particles was obtained by using the same cerium carbonate as in Example 1 and holding it in water at 95° C. for 6 hours. Next, a powder X-ray diffraction spectrum of the adsorbent was measured in the same manner as in Example 1.

### Comparative Example 1

An adsorbent made of cerium compound particles was obtained in the same manner as in Example 1 except that the heating temperature was set to 180° C. Next, a powder X-ray diffraction spectrum of the adsorbent was measured in the same manner as in Example 1.

### Comparative Example 2

An adsorbent made of cerium compound particles was obtained using the same cerium carbonate as in Example 1 except that wet milling was not performed, with the same manner as in Example 1 except that the heating temperature was set to 280° C. Next, a powder X-ray diffraction spectrum of the adsorbent was measured in the same manner as in Example 1.

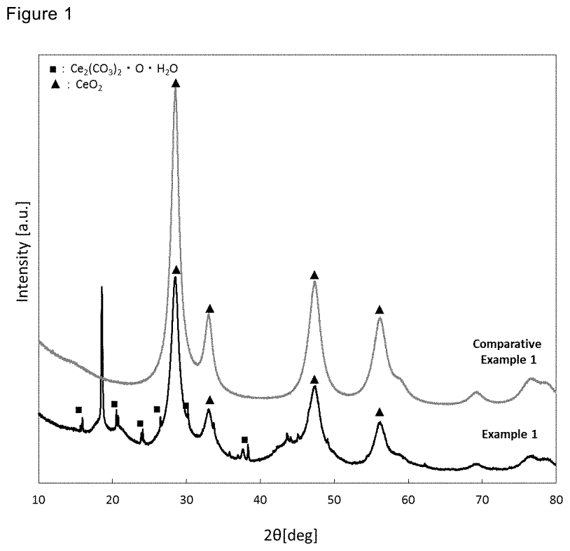

FIG. 1 shows powder X-ray diffraction spectra of the adsorbents comprising cerium compound particles of Example 1 and Comparative Example 1. From powder X-ray diffraction spectrum analysis, it can be seen that the adsorbent of Example 1 contains monooxycarbonate hydrate (Ce₂(CO₃)₂O·H₂O) and cerium oxide (CeO₂). On the other hand, it can be seen that the adsorbent of Comparative Example 1 does not contain monooxycarbonate hydrate.

In order to verify the peak intensity ratio in more details, the peak intensity ratio represented by I_{ca}/lₒₓ was calculated from monochromatic powder X-ray diffraction spectrum analysis for the adsorbents of Examples 1 to 4 and Comparative Examples 1 and 2, where I_{ca} is the peak intensity derived from cerium monooxycarbonate and lₒₓ is the peak intensity derived from cerium oxide. The peak intensity ratio for each cerium compound particle was as shown in Table 1.

A monochromatic powder X-ray diffraction apparatus (smart Lab manufactured by Rigaku Corporation) was used to carry out measurement with output: 45 kV, 200 mA; measurement range (deg): 10 to 80°; step width: 0.01 deg; scan speed: 1 deg/min; divergence slit (deg): ⅔; longitudinal slit: 10 mm, and a monochromatic powder X-ray diffraction spectrum was measured using a one dimensional detector.

### Evaluation of Fluorine Adsorption Performance of Adsorbent

A fluorine-containing solution (aqueous solution of ammonium fluoride) having a fluorine concentration of 100 mg/L was adjusted to pH3.0 with hydrochloric acid, and the adsorbents obtained in Examples 1 to 4 and Comparative Examples 1 and 2 were added thereto, followed by shaking at 25° C. for 24 hours, and then the fluorine concentration in the fluorine-containing solution was measured using a fluoride ion electrode (manufactured by Horiba Advanced Techno Co., Ltd.). The fluorine adsorption performance was evaluated according to the following criteria. The smaller this value means the more fluorine was able to be removed, which means that the fluorine adsorption capacity is large.

◯: The fluorine concentration in the fluorine-containing solution is less than 20 mg/L.

Δ: The fluorine concentration in the fluorine-containing solution is not more than 20 mg/L to 30 mg/L.

×: The fluorine concentration in the fluorine-containing solution is 30 mg/L or more.

The evaluation results were as shown in Table 1.

Further, the adsorbents of Examples 1 and 4 and Comparative Example 1 were measured for the powder X-ray diffraction spectra in the same manner as described above, even for the adsorbents after the fluorine adsorption performance evaluation.

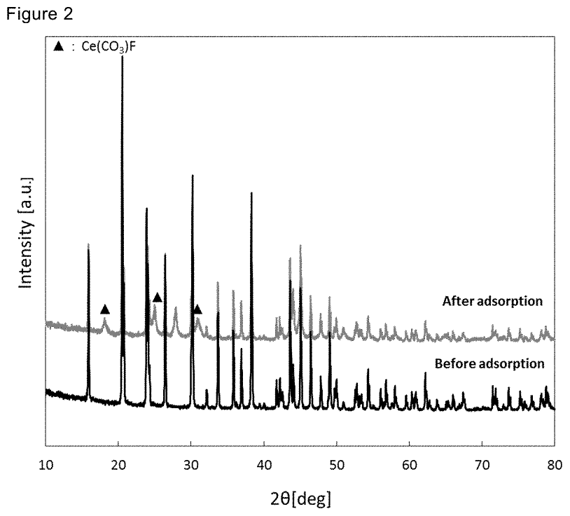

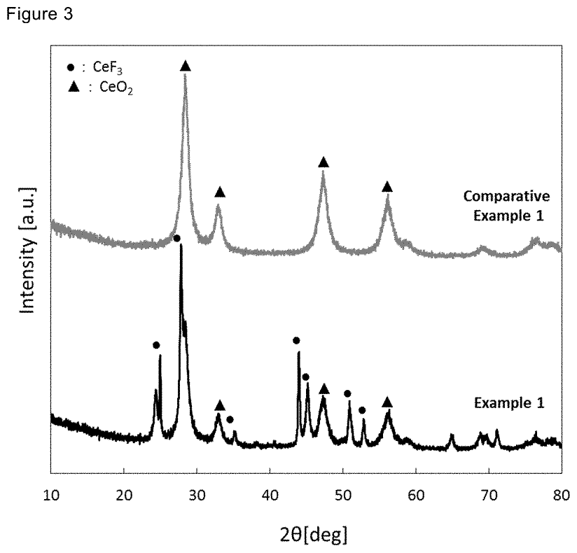

FIG. 2 shows the powder X-ray diffraction spectrum before and after the fluorine adsorption performance evaluation of the adsorbent of Example 4. FIG. 3 shows the powder X-ray diffraction spectra before and after the fluorine adsorption performance evaluation of the adsorbents of Example 1 and Comparative Example 1.

### Preparation of Adsorbent Molded Article

To 100 parts by mass each of the adsorbents of Examples 1 to 4 and Comparative Examples 1 and 2 obtained as described above were mixed 6.2 parts by mass (solid content: water content=50% by mass: 50% by mass) of acrylic ester copolymer aqueous emulsion (Polysol AP-1761, manufactured by Showa Denko K.K.) and 1.4 parts by mass of methyl cellulose (SM-4000, manufactured by Shin-Etsu Chemical Co., Ltd.) as a plasticizer, then pure water was added to the mixture, and kneaded products were obtained using a mixer (desktop mixer KMM760, manufactured by Aikosha MFG Co., Ltd.).

Next, the kneaded products were extruded into a stick shape with a screen having an opening of 0.6 mm by using an extrusion granulator (Disc Pelletizer PV-5S/11-200D type, manufactured by DALTON corporation), and subsequently, granulated products were obtained by using a sizing granulator (Mulmellizer-QJ-230T-2 type, manufactured by DALTON Corporation).

The obtained granulated products were dried by hot air at 100° C. for 10 minutes by using a dryer (fluidized dryer MGD80 type, manufactured by DALTON Corporation), and then adsorbent molded articles were obtained.

### Evaluation of Fluorine Adsorption Performance of Adsorbent Molded Article

Each adsorbent molded article using the adsorbents of Examples 1 to 4 and Comparative Examples 1 and 2 was filled in a column having a volume of 10 mL, and by further charging pure water therein and evacuating with a vacuum pump, air bubbles in the adsorbent molded article were removed. Then, 20 mg/L of fluorine-containing solution which was adjusted to pH3 with hydrochloric acid, was fed to the column by a feed pump so that the flow rate of water was 3.8 mL/min, and the fluorine concentration after the water passed through the column was measured in the same manner as described above, and the time when the fluorine concentration exceeded 2 mg/L was defined as the breakthrough time.

The fluorine adsorption performance was evaluated according to the following criteria.

⊚: The duration time of the fluorine concentration being 2 mg/L or less in the fluorine-containing solution is 200 hours or more.

∘: The duration time of the fluorine concentration being 2 mg/L or less in the fluorine-containing solution is 150 hours or more and less than 200 hours.

Δ: The duration time of the fluorine concentration being 2 mg/L or less in the fluorine-containing solution is 100 hours or more and less than 150 hours.

×: The duration time of the fluorine concentration being 2 mg/L or less in the fluorine-containing solution is less than 100 hours.

The evaluation results were as shown in Table 1.

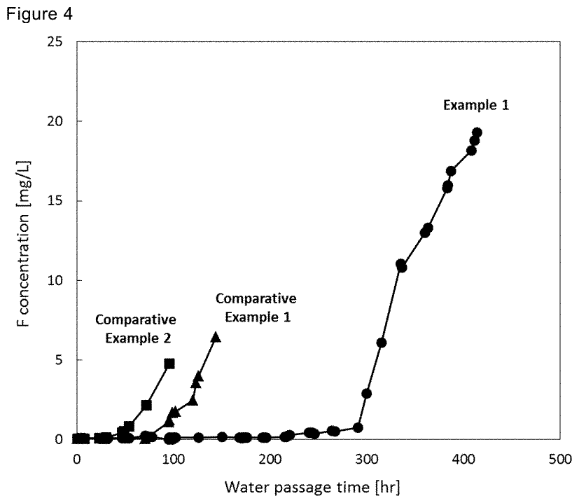

FIG. 4 shows changes in fluorine concentration with respect to the water passage time of the adsorbent molded articles of Example 1 and Comparative Examples 1 and 2.

The adsorption duration times of the adsorption molded articles of Examples 1 to 4 are all 150 hours or more, and it can be said that the breakthrough time of the adsorbent itself constituting the adsorbent molded article is long.

TABLE 1

| | | | | Fluorine Adsorption | Fluorine Adsorption | Powder X-ray |
|---|---|---|---|---|---|---|
| | | | | Performance Evaluation of | Performance Evaluation | Diffraction Analysis |
| | | Powder X-ray Diffraction | | Cerium Compound Particles | of Molded Article | Result after Fluorine |
| | | Analysis Result before | Peak | Figures in parentheses | Figures in parentheses | Adsorption |
| | Heating | Fluorine Adsorption | Intensity | indicate fluorine concentration | indicate breakthrough | Performance |
| | Condition | Performance Evaluation | Ratio I_{ca}/Iₒₓ | (mg/L) after 24 hours | time (hr) | Evaluation |
| Ex 1 | 140° C. | Ce₂ (CO₃)₂O · H₂O + | 0.29 | ○ | ⊚ | CeO₂, Ce(CO₃)F, |
| | (under air) | CeO₂ | | (18.4) | (290) | CeF₃ |
| Ex 2 | 120° C. | Ce₂ (CO₃)₂O · H₂O + | 0.53 | ○ | ⊚ | CeF₃ |
| | (under air) | CeO₂ | | (0.5) | (310) | |
| Ex 3 | 160° C. | Ce₂ (CO₃)₂O · H₂O + | 0.16 | Δ | ◯ | CeO₂, Ce(CO₃)F, |
| | (under air) | CeO₂ | | (28.8) | (180) | CeF₃ |
| Ex 4 | 95° C. | Ce₂ (CO₃)₂O · H₂O | — | ○ | ⊚ | Ce₂ (CO₃)₂O · H₂O, |
| | (in water) | | | (13.4) | (210) | Ce(CO₃)F, CeF₃ |
| Comp. | 180° C. | CeO₂ | — | Δ | Δ | CeO₂ |
| Ex 1 | (under air) | | | (29.0) | (110) | |
| Comp. | 280° C. | CeO₂ | — | × | × | CeO₂ |
| Ex 2 | (under air) | | | (30.2) | (70) | |

### Example 5

An adsorbent made of a lanthanum compound was obtained in the same manner as in Example 1 except that lanthanum carbonate octahydrate (manufactured by Nippon Yttrium Co., Ltd.) was used instead of cerium carbonate and the firing temperature was set to 500° C.

### Example 6

An adsorbent made of a neodymium compound was obtained in the same manner as in Example 1 except that neodymium carbonate octahydrate (manufactured by Wako Pure Chemical Industries, Ltd.) was used instead of cerium carbonate and the firing temperature was set to 500° C.

The adsorbents of Examples 5 and 6 were measured for the powder X-ray diffraction spectra and the fluorine adsorption performance was evaluated in the same manner as described above. The evaluation results were as shown in Table 2.

Since no rare earth oxide was detected in the adsorbents of Examples 5 and 6 by the powder X-ray diffraction spectrum, the calculation of I_{ca}/lₒₓ was omitted.

TABLE 2

| | | | Fluorine | |
|---|---|---|---|---|
| | | | Adsorption | |
| | | | Performance | |
| | | | Evaluation | |
| | | | of Cerium | |
| | | Powder X-ray | Compound | |
| | | Diffraction | Particles | Powder X-ray |
| | | Analysis | Figures in | Diffraction |
| | | Result before | parentheses | Analysis Result |
| | | Fluorine | indicate fluorine | after Fluorine |
| | | Adsorption | concentration | Adsorption |
| | Heating | Performance | (mg/L) after | Performance |
| | Conditions | Evaluation | 24 hours | Evaluation |
| Ex 5 | 500° C. | La₂•O₂•(CO₃) | ○ | La₂•O₂•CO₃, |
| | (under air) | | (3.6) | LaCO₅ |
| Ex 6 | 500° C. | Nd₂•O₂•(CO₃) | ○ | Nd₂•O₂•CO₃ |
| | (under air) | | (1.4) | |

1. An adsorbent comprising rare earth compound particles comprising a rare earth oxycarbonate or a hydrate thereof.

2. The adsorbent comprising according to claim 1, wherein
the rare earth compound particles further comprise a rare earth oxide.

3. The adsorbent comprising according to claim 1, wherein
the rare earth is at least one selected from the group consisting of La, Ce, Pr, Nd, Pm, Sm, Eu, Gd, Tb, Dy, Ho, Er, Tm, Yb, Lu, Y Lu, Y, and Sc.

4. The adsorbent according to claim 3, wherein
the rare earth is Ce.

5. The adsorbent comprising according to claim 2, wherein
a peak intensity ratio represented by I_{ca}/lₒₓ is 0.1 or more, when a peak intensity derived from the rare earth oxycarbonate or a hydrate thereof is defined as I_{ca} and a peak intensity derived from the rare earth oxide is defined as lₒₓ, in monochromatic powder X-ray diffraction analysis of the rare earth compound particles.

6. The adsorbent according to claim 1, used for a fluorine adsorbent.

7. The adsorbent according to claim 6, wherein
the rare earth compound particles further comprise at least one selected from the group consisting of a rare earth fluoride and a rare earth carbonate fluoride.

8. A method for producing the adsorbent according to claim 1, comprising
a step of heating a rare earth carbonate in a gas atmosphere containing oxygen at a temperature of 100° C. or higher and lower than 180° C. or in water at a temperature of 60° C. to 100° C.

9. A method for removing fluorine from a fluorine-containing solution using the adsorbent according to claim 1, comprising the steps of:
bringing the adsorbent into contact with the fluorine-containing solution; and
chemically reacting rare-earth compound particles in the adsorbent with fluorine in the fluorine-containing solution to form at least one kind of fluoride selected from the group consisting of a rare-earth fluoride and a rare-earth carbonate fluoride.

10. The adsorbent molded article comprising the adsorbent according to claim 1 and a binder.

11. The adsorbent molded article according to claim 10, wherein
the adsorbent is contained in an amount of 90% by mass or more with respect to the entire adsorbent molded article.

12. The adsorbent comprising according to claim 3, wherein
a peak intensity ratio represented by I_{ca}/lₒₓ is 0.1 or more, when a peak intensity derived from the rare earth oxycarbonate or a hydrate thereof is defined as I_{ca} and a peak intensity derived from the rare earth oxide is defined as lₒₓ, in monochromatic powder X-ray diffraction analysis of the rare earth compound particles.

13. The adsorbent comprising according to claim 4, wherein
a peak intensity ratio represented by I_{ca}/lₒₓ is 0.1 or more, when a peak intensity derived from the rare earth oxycarbonate or a hydrate thereof is defined as I_{ca} and a peak intensity derived from the rare earth oxide is defined as lₒₓ, in monochromatic powder X-ray diffraction analysis of the rare earth compound particles.
